(19) United States
(12) Patent Application Publication
(10) Pub. No.: US 2016/0019562 A1
(43) Pub. Date: Jan. 21, 2016

(54) OIKOS Delos

(71) Applicant: Janice A. Leahy, Windham, NH (US)

(72) Inventor: Janice A. Leahy, Windham, NH (US)

(73) Assignee: OIKOS SOFTWARE, INC., Windham, NH (US)

(21) Appl. No.: 14/331,352

(22) Filed: Jul. 15, 2014

(51) Int. Cl. G06Q 30/02

(52) U.S. Cl. CPC G06Q 30/0202

(57) ABSTRACT

OIKOS Delos is designed to accurately report Days Sales Outstanding (DSO) and forecast cash collections based on a DSO goal; tossing away the traditional metric formula and granulating to a level of data that will arm CFOs & Treasurers with substantive real facts. The OIKOS Delos program employs a revenue absorption methodology and business cycle in calculating actual Days Sales Outstanding collection and forecasting DSO required cash collection. The program has the capability to analyze specific data the user defines. For example, a user may want to DSO a specific customer or region, by a currency. As long as the user has access to the information; defines currency, ending AR for the customer or region, and actual (or forecasted) revenue streams for the customer or region, a DSO can be calculated or goaled.

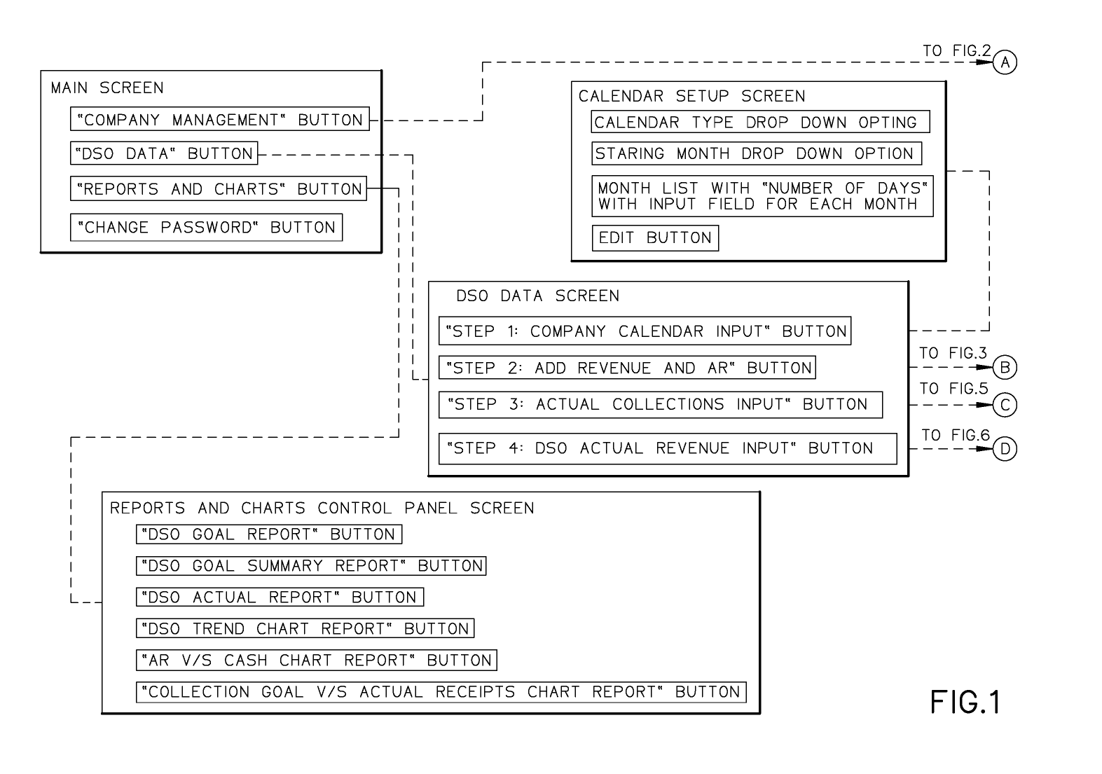

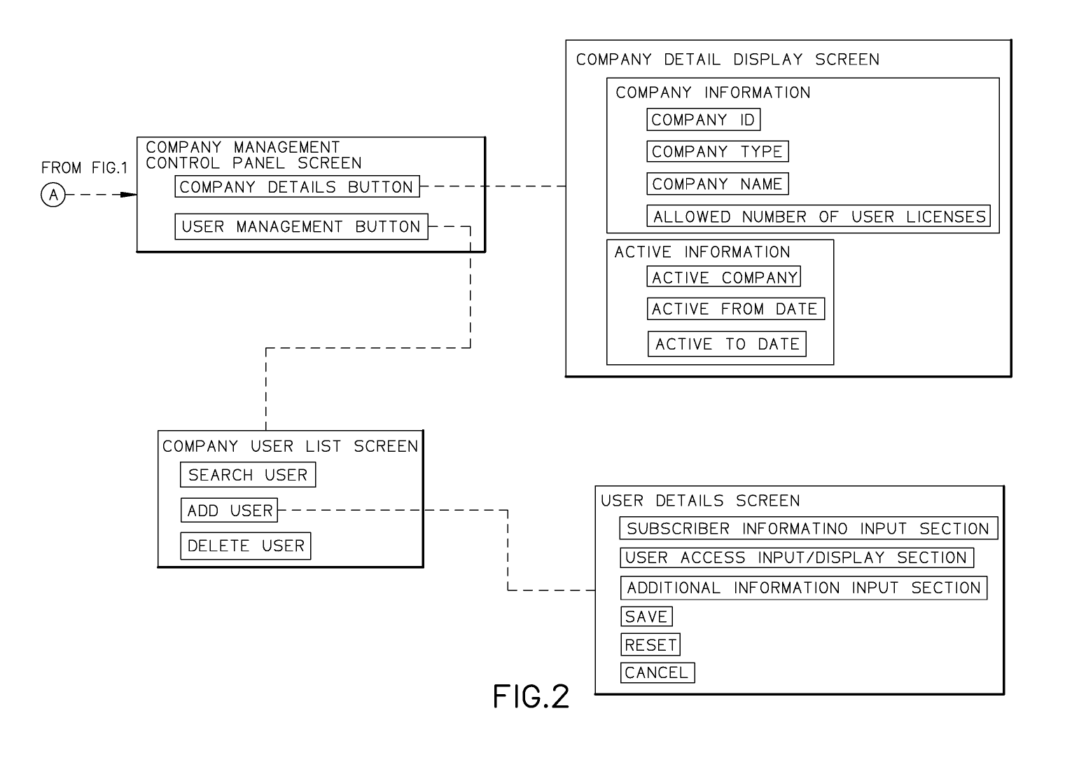

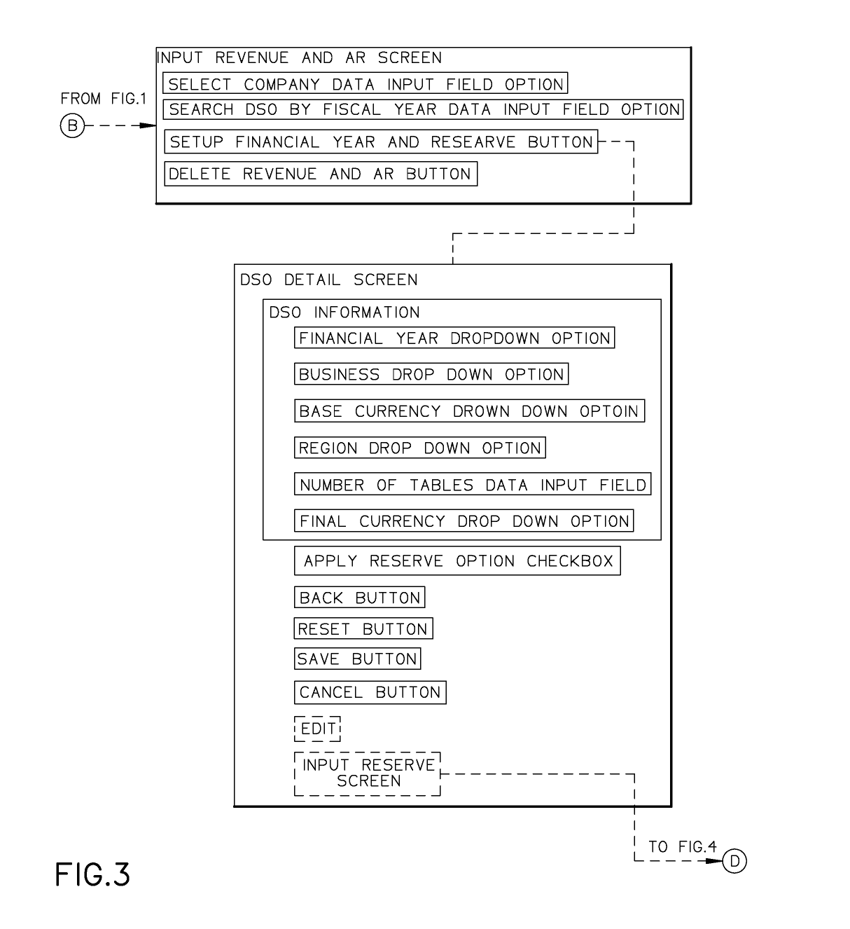

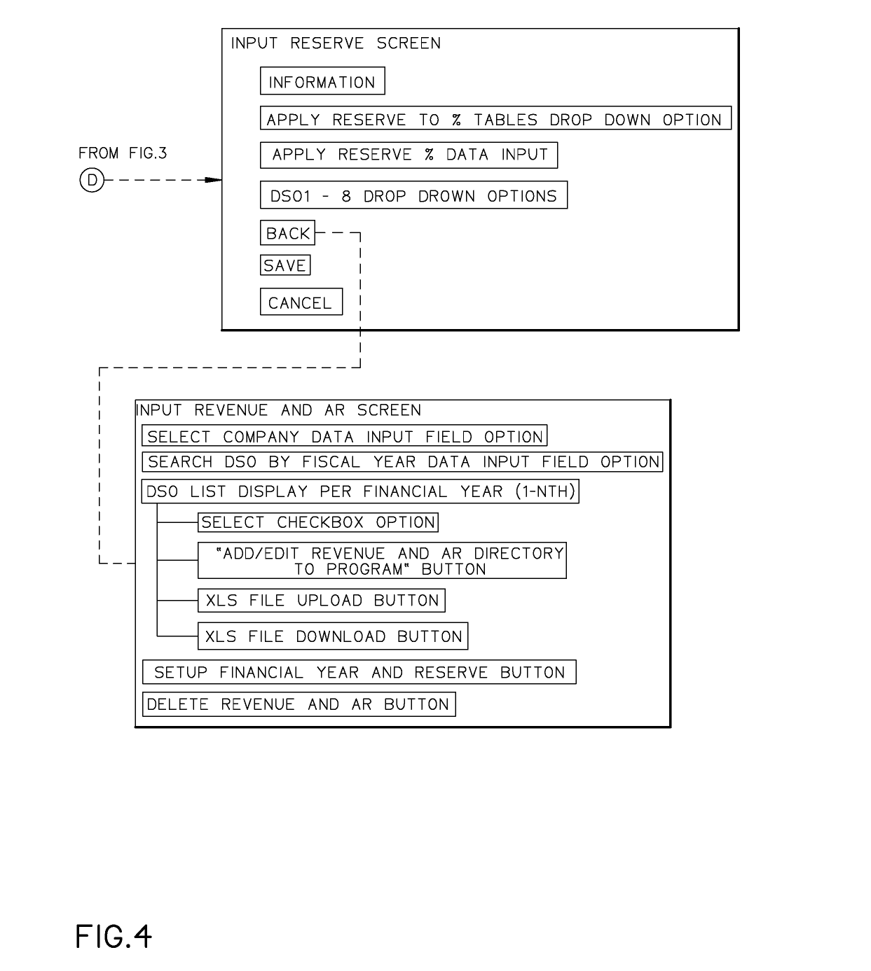

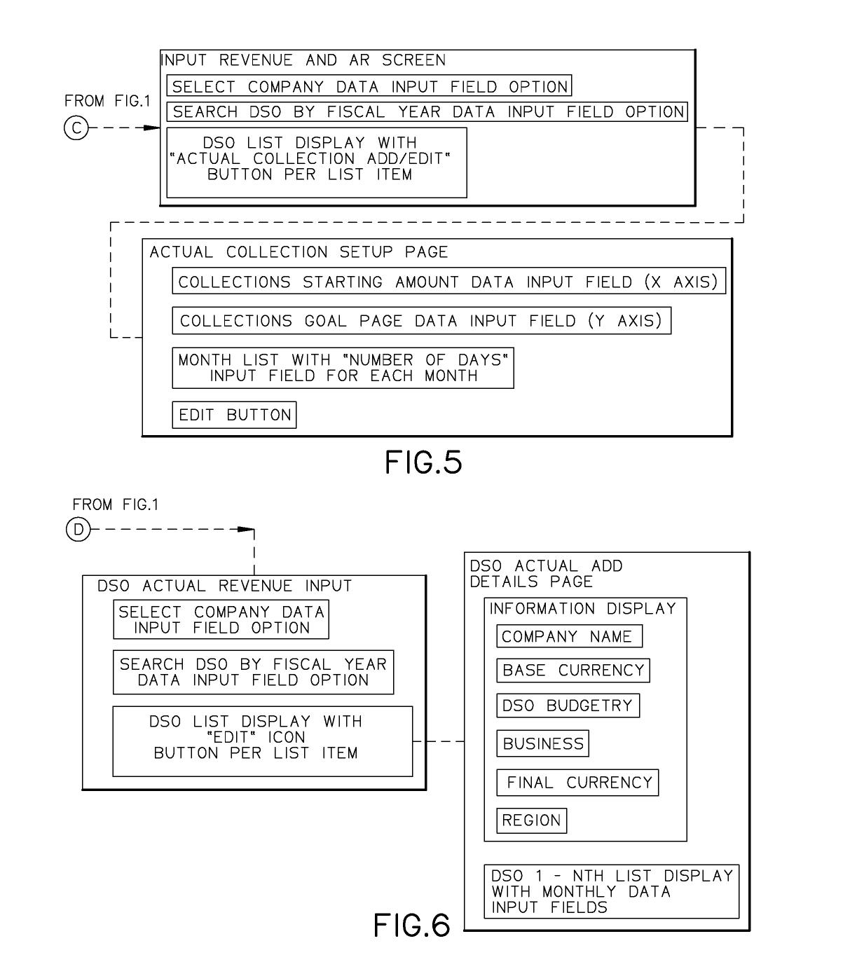

### PROBLEM THAT INVENTION SOLVES

OIKOS Delos is designed to accurately report Days Sales Outstanding (DSO); tossing away the traditional metric formula and granulating to a level of data that will arm CFOs & Treasurers with substantive real facts.

### How does Invention Solve Problem?

The OIKOS Delos program employs a revenue absorption methodology in calculating actual Days Sales Outstanding collection and forecasting DSO required collection. The program has the capability to analyze specific data the user defines.

For example, a user may want to DSO a specific customer or region, by a currency. As long as the user has access to the information; defines currency, ending AR for the customer or region, and actual (or forecasted) revenue streams for the customer or region, a DSO can be calculated or goaled.

### What Makes Invention Unique?

There isn't any software in existence that calculates forecasted Days Sales Outstanding or Actual Days Sales Outstanding.

### METHOD/SOFTWARE ELEMENTS

Quick snap-shot of information necessary to run OIKOS Delos:

1. The User needs the following information:

a. 15 months revenue streams (if you apply a reserve for AR purposes, execute the reserve functionality during input of the revenue streams).

i. The streams need to be consistent based on the parameters user defines (see examples below);

1. By Region/Entity/Jurisdiction;

2. By Salesperson, AR Collector;

3. By Product line/Segment/Product(s);

4. By Customer(s);

5. Choose Currency.

b. These revenue streams can be a combination of actual and forecasted revenues, or all actual revenue, or all forecasted revenue. Most businesses use a combination.

c. One Ending AR number representing the month preceding the calendar/fiscal period.

i. Example, your fiscal period is July 1 through June 30. You will need to input an Ending AR figure for the month preceding the analysis. This would be the preceding JUNE.

d. Twelve months of DSO targets for the calendar/fiscal year.

2. Set up the Calendar

a. Fiscal or Calendar? Input the number of days per month.

3. Input data into the program:

a. Revenue;

b. Select Currency;

c. Ending AR;

d. DSO goals (changing DSO's will give rise to a different cash requirement).

4. Charts

a. Actual collections can be input into the program for chart purposes

5. OIKOS Delos will generate a Report(s) and Chart(s) of the results.

### Which Elements Necessary/Optional?

Roles & Privileges—This is one of the core functionality of the application.

### Relationship Between Elements (Method/Software)

A SaaS financial management solution, OIKOS Delos securely elements (method/software) provides an online Windows financial advanced capability without requiring traditional on premises deployment or maintenance—simply access and you're ready to go. Replace outdated and inaccurate spreadsheets with added control and transparency to your company's cash positions.

### Element Relationship (Method/Software) Continued

Technology—OIKOS Delos software is web-based and data is stored in SQL Server database.

What is claimed is:

1. OIKOS software featuring Delos is designed to accurately report Days Sales Outstanding (DSO).

2. OIKOS software featuring Delos is designed to accurately forecast required cash collection(s) based on a Days Sales Outstanding (DSO) goal(s).

3. OIKOS software featuring Delos is designed to accurately summarize forecast required cash collection(s) based on a Days Sales Outstanding (DSO) goal(s) to parameters set by the user.

4. OIKOS software featuring Delos is designed to accurately, chart Days Sales Outstanding (DSO) trends.

5. OIKOS software featuring Delos is designed to accurately chart Days Sales Outstanding (DSO) cash collection goals against actual cash collections.
